(19) United States
(12) Patent Application Publication
(10) Pub. No.: US 2024/0428358 A1
(43) Pub. Date: Dec. 26, 2024

(54) SCHOOL ADMISSION PREDICTION SYSTEM AND METHOD

(71) Applicant: Direction EdTech INC., Taipei city (TW)

(72) Inventors: Chih-Hsien Hsia, Yilan County (TW); Po-Han Wu, New Taipei City (TW); Liang-Ying Ke, Yilan County (TW); Pai-Pei Szeto, Taipei City (TW); An-Ting Hsiao, Taipei City (TW)

(73) Assignee: Direction EdTech INC., Taipei city (TW)

(21) Appl. No.: 18/239,763

(22) Filed: Aug. 30, 2023

(30) Foreign Application Priority Data
Jun. 21, 2023 (CN) 202310740454.1

(51) Int. Cl. G06Q 50/20; G06N 20/00

(52) U.S. Cl. CPC G06Q 50/2053; G06N 20/00

(57) ABSTRACT

A school admission prediction system and method are provided. The system includes a user interface for receiving personal data from an applicant, including academic and activity data. A data acquisition module connected to the user interface acquires this personal data. A data preprocessing module connected to the data acquisition module preprocesses the academic and activity data. An attribute selection module connected to the data preprocessing module extracts multiple attributes from the preprocessed data. A machine learning model generates an evaluation report based on the extracted attributes. This report includes a prediction of whether the applicant will be admitted to the school. The system also includes a loss calculation module for evaluating the performance of the machine learning model and optimizing its parameters based on the evaluation results. The method and system provide a reliable and efficient way to predict school admissions, helping applicants to better prepare their applications.

### BACKGROUND OF THE INVENTION

### 1. Field of the Invention

The present invention generally relates to the field of machine learning and data analysis. More specifically, it pertains to a system and method for predicting school admissions based on applicants' personal data.

### 2. Description of the Prior Art

Applying to schools, especially higher education institutions such as universities and colleges, can be a complex and stressful process for many students. One of the major challenges is the uncertainty involved in the admissions process. Each school typically has its criteria for evaluating applicants, which may include academic performance, standardized test scores, extracurricular activities, volunteer work, personal statements, recommendation letters, and more. However, the importance of these factors can vary greatly among different schools, and for applicants, this process is often quite opaque.

Furthermore, many institutions have highly competitive admissions, which means even highly qualified applicants may not be accepted. This uncertainty can lead to anxiety, stress, and difficulties in planning for the future. Therefore, there is a need for a tool that can provide applicants with more personalized and accurate predictions of their admission chances.

There are some solutions available in the market that attempt to predict the likelihood of entry into specific schools based on certain factors. However, these solutions often rely on simplistic models that do not take into account the complex interactions of various factors in the admissions process. Additionally, these models are often based on outdated data and cannot adapt to changes in admission policies and trends.

Therefore, we need a more comprehensive and flexible system that can provide more accurate and personalized predictions for school admissions. Such a system would help students, parents, and education counselors plan and make informed decisions during the school application process.

### SUMMARY OF THE INVENTION

In view of the aforementioned problems, one objective of the present invention is to provide a more comprehensive and flexible system and method for predicting school admissions.

In accordance with the above and other objectives, the present invention provides a school admission prediction system suitable for evaluating the personal data of at least one applicant to determine whether they will be admitted to a school. The school admission prediction system comprises several components, namely a user interface, a data acquisition module, an attribute selection module, and a machine learning model. The user interface allows applicants to input their personal data and the school they wish to apply to, while the data acquisition module is used to retrieve the personal data of the applicants. Once the data is acquired, it undergoes preprocessing by a data preprocessing module. Subsequently, the attribute selection module extracts multiple attributes from the preprocessed academic and activity data. Then, the machine learning model utilizes these attributes to generate an evaluation report assessing the applicant's likelihood of admission to the school, and this evaluation report is displayed to the applicant through the user interface.

In addition, the machine learning model includes a loss calculation module for evaluating the performance of the machine learning model. The training process of the machine learning model involves connecting the data acquisition module to a database that stores multiple previous application data, including the academic and activity data of previous applicants, the applied schools, and admission data. The data acquisition module retrieves these previous application data from the database, which is then preprocessed by the data preprocessing module. Next, the attribute selection module extracts multiple attributes from the preprocessed previous application data. The machine learning model is trained using these attributes and admission data. After training, the performance of the model is evaluated and the evaluation results are generated using the loss calculation module. Based on the evaluation results, the model's parameters are optimized until the evaluation results are below a predetermined threshold.

In the aforementioned school admission prediction system, the attribute selection module further evaluates the importance of each attribute in the training process of the machine learning model. This evaluation is based on feedback from the machine learning model. If the feedback indicates that an attribute is important, it is retained; if the feedback indicates that an attribute is not important, it is removed.

In the aforementioned school admission prediction system, the machine learning model is a multilayer perceptron model.

In the aforementioned school admission prediction system, the attributes include at least one of the following: average GPA, volunteer work, work experience, extracurricular activities, applicant's interests, and standardized test scores. Additionally, the attributes also include at least one of the following: applicant's gender, applicant's nationality, and the admission rate of the school.

In accordance with the above and other objectives, the present invention also provides a method for predicting school admissions, comprising the following steps. Firstly, the method receives the personal data of the applicant, including academic data and activity data, through a user interface. Then, the data acquisition module retrieves this personal data. Subsequently, the data preprocessing module preprocesses the academic data and activity data of the applicant. Next, the attribute selection module extracts multiple attributes from the preprocessed academic data and activity data. The machine learning model generates an evaluation report based on the attributes passed by the attribute selection module, assessing whether the applicant can be admitted to the school. This evaluation report is sent to the user interface for display.

During the training process, the data acquisition module of the machine learning model is connected to a database that stores multiple previous application data, including the academic data and activity data of previous applicants, the applied schools, and admission data. The data acquisition module retrieves these previous application data from the database, which is then preprocessed by the data preprocessing module. Next, the attribute selection module extracts multiple attributes from the preprocessed application data. The machine learning model is trained using these attributes and admission data. During training, the loss calculation module is utilized to evaluate the performance of the model and generate evaluation results. The parameters of the machine learning model are optimized based on the evaluation results until the evaluation results are below a predetermined threshold.

The school admission prediction system and method of the present invention can comprehensively and effectively predict school admissions outcomes. By utilizing advanced machine learning techniques, it accurately predicts the likelihood of a student being admitted based on their academic and activity data.

The accompanying drawings are incorporated in and constitute a part of this application and, together with the description, serve to explain the principles of the invention in general terms. Numerals refer to parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates an embodiment of the school admission prediction system of the present invention.

FIG. 2 depicts the training process of the school admission prediction system.

FIG. 3 shows an example implementation of the multilayer perceptron model.

FIG. 4 illustrates the operational mode of the school admission prediction system during use.

### DETAILED DESCRIPTION OF THE INVENTION

In order to describe in detail the technical content, structural features, achieved objectives, and effects of the instant application, the following detailed descriptions are given in conjunction with the drawings and specific embodiments. It should be understood that these embodiments are only used to illustrate the application and not to limit the scope of the instant application.

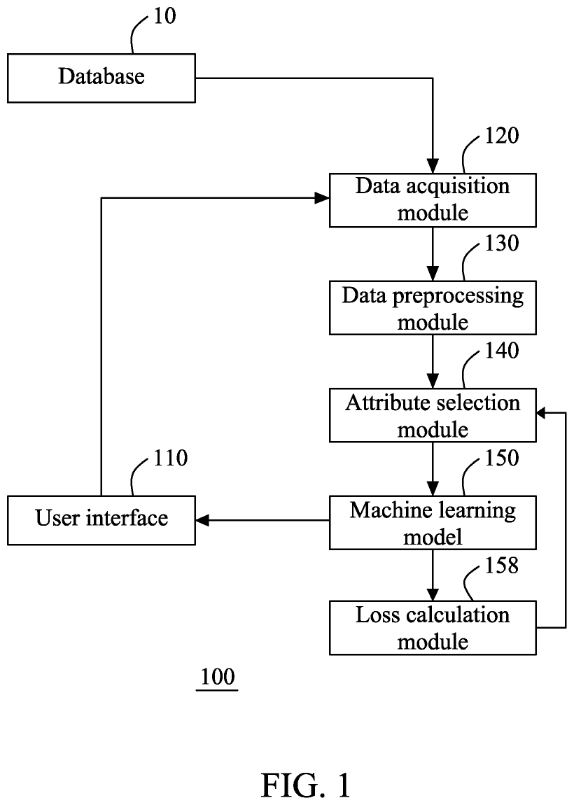

Please refer to FIG. 1. FIG. 1 illustrates an embodiment of the school admission prediction system in the present invention. This school admission prediction system 100 comprises a user interface 110, a data acquisition module 120, a data preprocessing module 130, an attribute selection module 140, and a machine learning model 150. The user interface 110 is responsible for receiving the personal data of at least one applicant, including academic data and activity data. The data acquisition module 120 is connected to the user interface 110 and is designed to retrieve this personal data. The data preprocessing module 130 is connected to the data acquisition module 120 and preprocesses the academic data and activity data of the applicant. The attribute selection module 140 is connected to the data preprocessing module 130 and extracts multiple attributes from the preprocessed academic data and activity data. The machine learning model 150 is connected to the attribute selection module 140 and the user interface 110. It generates an evaluation report based on the attributes passed from the attribute selection module 140, which includes an assessment of whether the applicant can be admitted to the school. The machine learning model 150 then sends the evaluation report to the user interface 110 for display.

The machine learning model 150 also includes a loss calculation module 158, primarily applied during the training process of the machine learning model 150. The loss calculation module 158 is used to evaluate the performance of the machine learning model 150 and generate an evaluation result. Based on this evaluation result, the parameters of the machine learning model 150 are optimized until the evaluation result is below a predetermined threshold. To clarify, in FIG. 1, the loss calculation module 158 is depicted separately from the machine learning model 150. However, those skilled in the art would understand that the loss calculation module 158 is actually a part of the machine learning model 150.

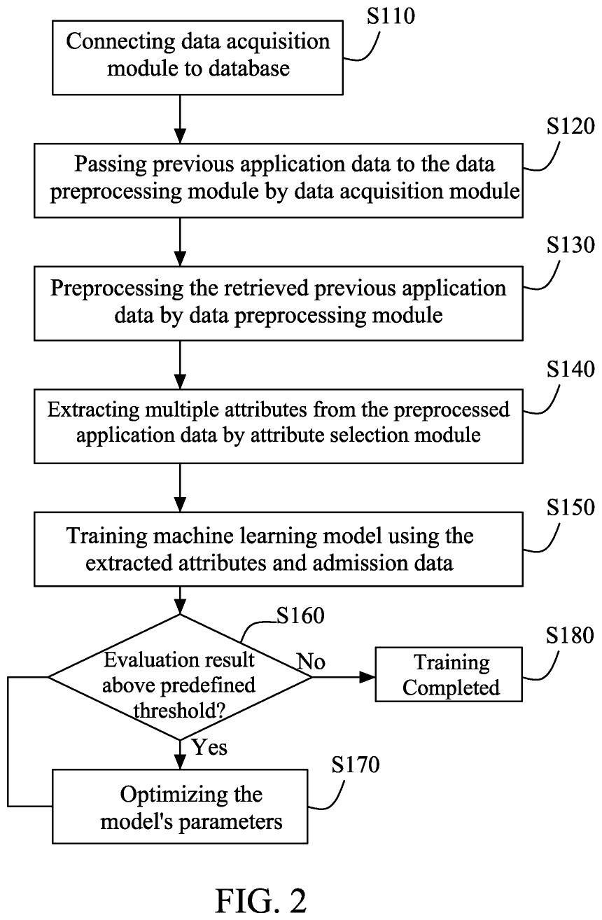

Next, we will describe the training process of the machine learning model 150, referring to both FIG. 1 and FIG. 2. First, please refer to step S110, where the data acquisition module 120 is connected to a database 10. The database 10 stores multiple previous application data. Each previous application data includes at least the following: academic data and activity data of previous applicants, the applied schools, and admission data. Here, previous applicants refer to applicants who have previously applied to schools, and previous application data refers to the data submitted by these previous applicants during their school applications. Admission data includes both data for applicants accepted by the schools and data for applicants rejected by the schools. Next, please refer to step S120, where the data acquisition module 120 retrieves the previous application data from the database 10 and passes it to the data preprocessing module 130.

Next, please refer to step S130, where the data preprocessing module 130 preprocesses the retrieved previous application data. This preprocessing process may involve various techniques such as data cleaning and normalization to ensure that the data is in an appropriate format for subsequent steps. Data cleaning involves handling missing or inconsistent data, as they can lead to inaccurate predictions. For example, if the average Grade Point Average (GPA) of an applicant is missing, the data preprocessing module 130 may calculate the average GPA from the available overall previous application data to fill in the missing value. Additionally, normalization aims to adjust the values of numerical ranges to a scale of [0, 1]. For example, if some applicants have their GPA based on a scale of 4.0, while others have their GPA based on a scale of 100, the data preprocessing module 130 will normalize these values to a scale of [0, 1].

After preprocessing the previous application data, proceed to step S140, where the attribute selection module 140 extracts multiple attributes from the preprocessed application data. These attributes are the features that will be used by the machine learning model 150 during the training process. In other words, the attribute selection module 140 is used during the training phase to determine which data features will be used to train the machine learning model 150. The selected attributes can be directly obtained from the preprocessed data, such as the applicant's GPA, standardized test scores, the number of extracurricular activities, as well as volunteer work, work experience, and the applicant's interests. However, the attribute selection module 140 can also derive new attributes based on the preprocessed data. For example, it can calculate the ratio of academic and non-academic activities or create an attribute representing the diversity of the applicant's activities. The selection of attributes is not arbitrary; the attribute selection module 140 uses statistical methods or machine learning algorithms to determine which attributes are most relevant to the prediction task. For instance, it may use a correlation coefficient matrix to identify the attributes that are most closely related to successful admissions. Alternatively, it can use machine learning algorithms to evaluate the importance of attributes.

In detail, the attribute selection process can occur during the training process of the machine learning model 150, where the importance of each attribute is evaluated based on feedback from the machine learning model 150. For example, we can add or remove attributes and observe the convergence speed of the machine learning model 150 or evaluate it during testing. If the results indicate that an attribute is important, we retain that attribute. Conversely, if the results suggest that an attribute is not important, we remove it. In this embodiment, the inventors discovered through the training process of the machine learning model 150 that attributes such as applicant's gender, nationality, and school admission rate also play important roles in determining school admissions outcomes.

In addition to selecting the most relevant attributes, the attribute selection module 140 may also be used to reduce the dimensionality of the data. By selecting a subset of potential attributes, the computational complexity of the machine learning model 150 can be reduced, overfitting can be prevented, and the interpretability of the machine learning model 150 can be improved. Once the attribute selection module 140 chooses the attributes, it passes them to the machine learning model 150 for training. The selected attributes form the input feature set that the machine learning model 150 uses to learn the relationship between applicant data and admission outcomes.

Next, proceed to step S150, where the machine learning model 150 is trained using the extracted attributes and admission data. This training process involves inputting the attributes and corresponding admission outcomes into the model, allowing it to learn the patterns and relationships that determine admission outcomes. During training, the performance of the machine learning model 150 is evaluated by the loss calculation module 158 (as in step S160). The loss calculation module 158 generates an evaluation result to measure how well the model is performing. If the evaluation result is above a predefined threshold, indicating that the performance of the machine learning model 150 is not satisfactory, the model's parameters are optimized (as in step S170). This evaluation and optimization process continues until the evaluation result falls below the predefined threshold. At this point, it indicates that the performance of the machine learning model 150 meets expectations, i.e., the training is completed (as in step S180). After completing the training process of the machine learning model 150, it can be used to predict admission outcomes based on the personal data of new applicants.

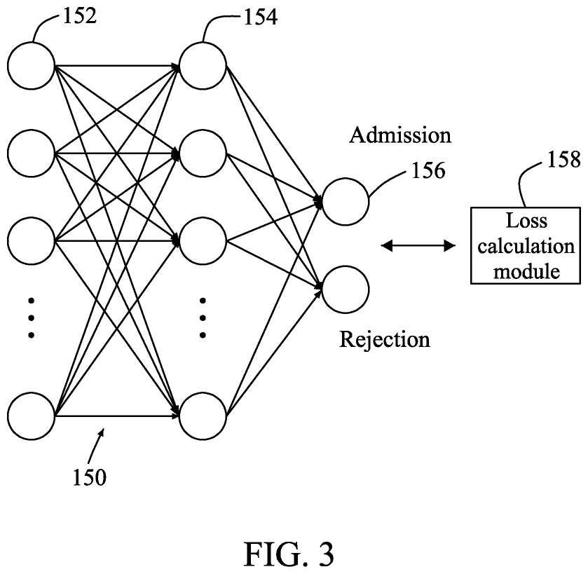

In the above embodiment, the machine learning model 150 can be a Multilayer Perceptron (MLP) model, as shown in FIG. 3, which is an artificial neural network. It consists of at least three layers of nodes: an input layer 152, one or more hidden layers 154, and an output layer 156. Nodes (or neurons) in each layer are connected to each node in the next layer through a set of weights. The input layer 152 receives the attributes selected by the attribute selection module 140, the hidden layers 154 are responsible for learning complex patterns in the data, and the output layer 156 generates the final prediction, which is the likelihood of an applicant being admitted to the target school.

During the training process, the Multilayer Perceptron (MLP) model uses a supervised learning technique and optimizes the weights between nodes using the backpropagation technique. In the forward phase, the MLP model makes predictions on the training data and compares the predictions with the ground truths. This difference is quantified as an error or loss, which is calculated by the loss calculation module 158. The MLP model then optimizes the weights in the network to minimize this loss. This process is repeated for multiple iterations until the MLP model achieves satisfactory performance on the training data or reaches a specified number of iterations. Due to the MLP model's ability to learn and model non-linear and complex relationships, it can play an important role in capturing the complexity of factors influencing school admissions.

In the aforementioned MLP model, a Softmax function can be added after the output layer. The Softmax function is a normalization function that transforms a vector of K real values into a vector of real values whose sum is 1. Therefore, the output of the Softmax function can be interpreted as probabilities. Consequently, in the MLP model of this embodiment, the Softmax function converts the outputs of two neurons in the output layer (representing admission and rejection) into two probabilities whose sum is 1. This way, the output of the MLP model can be interpreted as the probability of an applicant being admitted and the probability of being rejected.

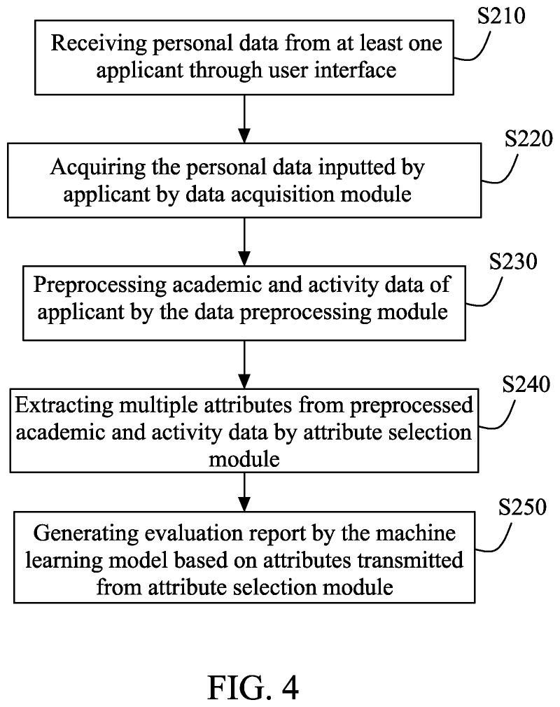

After the training is completed, the school admission prediction system 100 can be used by applicants to schools. Please refer to FIG. 4, which illustrates the operation of the school admission prediction system during the usage process. In the usage process, as shown in step S210, the user interface 110 of the school admission prediction system 100 first receives personal data from at least one applicant, including multiple academic and activity data. Then, as shown in step S220, the data acquisition module 120 connected to the user interface 110 acquires the personal data inputted by the applicant. After that, as shown in step S230, the data preprocessing module 130 preprocesses the academic and activity data of the applicant. Upon preprocessing, step S240 is executed, and the attribute selection module 140 extracts multiple attributes from the preprocessed academic and activity data. Then, in step S250, the machine learning model 150 generates an evaluation report based on the attributes transmitted from the attribute selection module 140. The evaluation report includes an assessment of whether the applicant can be admitted to the school, as well as the probability of the applicant being admitted or rejected by the school. Finally, the evaluation report is sent to the user interface 110 for display.

In the present invention, the user interface 110 can have different embodiments depending on the needs. For example, the user interface 110 can be a web-based interface accessed through a browser, allowing applicants to access the School admission prediction System 100 from any device with internet connectivity. Additionally, the user interface 110 can also be a dedicated application designed for mobile devices (such as smartphones) or desktop computers. This would provide a more personalized user experience with features such as offline data input, push notifications, and integration with other applications or services. Moreover, the user interface 110 can be designed to guide applicants through the process of inputting data, providing prompts when necessary. Furthermore, the user interface 110 displays the evaluation report generated by the machine learning model 150 in a clear and understandable manner. This may include visual elements such as graphs or charts, as well as textual explanations of the results.

In summary, the present invention provides a comprehensive and efficient school admission prediction system and method. By employing advanced machine learning techniques, particularly the multilayer perceptron model, the school admission prediction system of the present invention accurately predicts the likelihood of a student being admitted to a school based on their academic and activity data. Furthermore, in the present invention, the data preprocessing module and attribute selection module work together to clean, standardize, and extract relevant attributes from the data. The machine learning model then utilizes these attributes for accurate prediction and displays the results to the user (i.e., the applicant). Additionally, the school admission prediction system of the present invention can adapt and maintain accuracy and relevance over time by evaluating and adjusting the importance of each attribute or adding new attributes based on the feedback from the machine learning model. This adaptability, coupled with the high predictive accuracy of the school admission prediction system, makes it a valuable tool for students in the school admissions process.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A school admission prediction system for assessing personal data of at least one applicant to determine if the applicant will be admitted to a school, the school admission prediction system comprising:
a user interface for the applicant to input their personal data and at least one desired school for admission, wherein the personal data includes at least one academic data and at least one activity data;
a data acquisition module, connected to the user interface, configured to acquire personal data;
a data preprocessing module, connected to the data acquisition module, configured to pre-process the academic data and activity data of the applicant;
an attribute selection module, connected to the data preprocessing module, configured to extract multiple attributes from the preprocessed academic data and activity data; and
a machine learning model, connected to the attribute selection module and the user interface, configured to generate an evaluation report based on the attributes transmitted from the attribute selection module, wherein the evaluation report includes an assessment of whether the applicant can be admitted to the desired school, and the machine learning model sends the evaluation report to the user interface for display;
wherein the machine learning model further includes a loss calculation module, and a training process of the machine learning model includes a plurality of steps:
connecting the data acquisition module of the school admission prediction system to a database, wherein the database stores multiple previous application data, each of the previous application data includes academic data and activity data of previous applicants, the schools applied by the previous applicants, and admission data;
retrieving the previous application data from the database by the data acquisition module;
preprocessing the retrieved previous application data by preprocessing module;
extracting multiple attributes from the preprocessed previous application data by the attribute selection module;
training the machine learning model using the extracted attributes and admission data;
evaluating the performance of the machine learning model and generating an evaluation result through the loss calculation module, optimizing the parameters of the machine learning model according to the evaluation result until the evaluation result is less than a predetermined threshold.

2. The school admission prediction system as claimed in claim 1, wherein the attribute selection module is further configured to evaluate the importance of each attribute during the training process of the machine learning model, based on feedback from the machine learning model, and the attribute is retained if the feedback indicates that the attribute is important or removed if the feedback indicates that the attribute is not important.

3. The school admission prediction system as claimed in claim 2, wherein the attribute selection module can also derive new attributes based on the preprocessed data.

4. The school admission prediction system as claimed in claim 1, wherein the attribute selection module can also derive new attributes based on the preprocessed data.

5. The school admission prediction system as claimed in claim 1, wherein the machine learning model is a multilayer perceptron model.

6. The school admission prediction system as claimed in claim 1, wherein the attributes include at least one of the following: average GPA, volunteer work, work experience, extracurricular activities, interests of the applicant, and standardized test scores.

7. The school admission prediction system as claimed in claim 6, wherein the attributes further include at least one of the following: the applicant's gender, the applicant's nationality, and the admission rate of the school.

8. The school admission prediction system as claimed in claim 1, wherein the attribute selection module can also derive new attributes based on the preprocessed data.

9. A method for predicting school admissions, comprising:
receiving personal data from at least one applicant through a user interface, wherein the personal data includes at least one piece of academic data and at least one piece of activity data;
acquiring the personal data through a data acquisition module connected to the user interface;
preprocessing the academic data and activity data of the applicant through a data preprocessing module connected to the data acquisition module;
extracting multiple attributes from the preprocessed academic data and activity data through an attribute selection module connected to the data preprocessing module;
a machine learning model generating an evaluation report based on the attributes transmitted from the attribute selection module, wherein the evaluation report includes an assessment of whether the applicant can be admitted to the school, and transmitting the evaluation report to the user interface for display;
wherein a training process of the machine learning model includes the following steps:
connecting the data acquisition module of the school admission prediction system to a database, where the database stores multiple pieces of previous application data, each piece of previous application data includes at least: academic data and activity data of the previous applicant, the schools applied to by the previous applicant, and admission data;
retrieving the previous application data from the database through the data acquisition module; and
preprocessing the retrieved application data through the data preprocessing module;
extracting multiple attributes from the preprocessed application data through the attribute selection module;
training the machine learning model using the extracted attributes and admission data;
evaluating the performance of the machine learning model and generating an evaluation result through a loss calculation module, optimizing the parameters of the machine learning model according to the evaluation result until the evaluation result is less than a predetermined threshold.

10. The school admission prediction method as claimed in claim 9, wherein the attribute selection module further evaluates the importance of each attribute during the training process of the machine learning model, based on feedback from the machine learning model, and the attribute is retained if the feedback indicates that the attribute is important or removed if the feedback indicates that the attribute is not important.

11. The school admission prediction method as claimed in claim 9, wherein the machine learning model is a multilayer perceptron model.

12. The school admission prediction method as claimed in claim 9, wherein the attributes include at least one of the following: average GPA, extracurricular activities, volunteer work, work experience, interests of the applicant, and standardized test scores.

13. The school admission prediction method as claimed in claim 12, wherein the attributes further include at least one of the following: the applicant's gender, the applicant's nationality, and the school's admission rate.
